(19) United States
(12) Patent Application Publication
(10) Pub. No.: US 2017/0022727 A1
(43) Pub. Date: Jan. 26, 2017

(54) Flow-Control and Fluid Conservation Apparatus

(71) Applicants: Casey Pinkston, Kemp, TX (US); Richard Christopher Pinkston, Kemp, TX (US)

(72) Inventors: Casey Pinkston, Kemp, TX (US); Richard Christopher Pinkston, Kemp, TX (US)

(21) Appl. No.: 15/205,837

(22) Filed: Jul. 8, 2016

Related U.S. Application Data
(60) Provisional application No. 62/189,798, filed on Jul. 8, 2015.

(51) Int. Cl. E04H 4/14; F16K 13/00

(52) U.S. Cl. CPC E04H 4/14; F16K 13/00

(57) ABSTRACT

A flow-control apparatus for preventing the undesired loss of chemically-treated water from a swimming pool through the pool's overflow drain. A user of the flow-control apparatus may secure the flow-control apparatus to the pool's overflow drain and/or adjust the flow-control apparatus accordingly to block access to the overflow drain during periods of standard pool operation. If access to the overflow drain is needed, such as during a storm, the user may simply remove the flow-control apparatus and/or adjust the flow-control apparatus accordingly to allow access to the overflow drain. Accordingly, a flow-control apparatus is provided to limit the amount of unwanted water loss from a swimming pool.

### CROSS-REFERENCE TO RELATED APPLICATIONS

This application claims the benefit of provisional patent application Ser. No. 62/189,798, filed Jul. 8, 2015, by the present inventors.

### TECHNICAL FIELD

The present apparatus relates generally to water conservation; and, in particular, to the conservation of chemically-treated water in swimming pools.

### BACKGROUND

The Center for Disease Control and Prevention estimates that there are over ten million residential and commercial swimming pools in the United States. Often viewed as a luxury retreat for many homeowners, the average yearly cost for maintaining a pool is about $3,000 a year depending on the size of the pool.

Typical pool maintenance costs generally involve the standard costs for cleaning, running the pumps, and standard repair. However, one of the most important aspects of pool maintenance, and the associated cost, is maintaining the appropriate chemical balance in the pool. An improperly-balanced pool yields many problems, including corrosion of pool components, ineffectiveness against controlling germs and bacteria, and even safety concerns for pool users. Accordingly, maintaining a consistent volume of water in the pool is critical to the maintenance of a pool, as improper pool water levels produce many detrimental effects, including improper pH levels in the water and ineffective filtration and circulation.

To help maintain a consistent water level, most pools incorporate an overflow drain to drain excess water out of the pool. Although the overflow drain has an important utility of draining excess water after storms, chemically-treated water is also drained—and wasted—during regular pool usage. For a 600 square foot pool with a 1.5-inch overflow drain, an estimated 560 gallons of chemically-treated water, on average, escapes the pool through the overflow drain over the course of a single week. This equates to approximately 29,120 gallons of chemically-treated water which is wasted over the course of an entire year. Accounting for the cost of chemicals and water, approximately $1,131 per pool is wasted down the overflow drain yearly. Such a loss is felt even heavier in states experiencing heavy drought, such as California and Arizona—two of the top states which feature the most pools. For example, California, which has an estimated 1.1 million swimming pools, loses an estimated 32 billion gallons of water down the overflow drain per year, equating to approximately $1.24 billion worth of wasted chemically-treated water. To date, no known apparatus exists which regulates the amount of chemically-treated water escaping the swimming pool through the overflow drain.

### SUMMARY OF THE INVENTION

In accordance with the invention, undesirable loss of chemically-treated water in a swimming pool may be minimized through the utilization of a flow-control apparatus which attaches and/or mounts onto the pool overflow drain cover. Such a flow-control apparatus can regulate and/or control the amount of chemically-treated water which flows into and out of a pool's overflow drain, thereby achieving a significant, if not complete, reduction in the amount of chemically-treated water escaping the swimming pool through the pool's overflow drain.

Control of the water flow into and out of the overflow drain can be achieved through manual and/or automatic operation of the flow-control apparatus. In a particular embodiment of the invention, the flow-control apparatus may be attached directly to the overflow drain and cover the entirety of the overflow drain to ensure no chemically-treated water escapes the pool down the overflow drain. In another particular embodiment, the flow-control apparatus may be attached directly to the overflow drain and feature a slideable window to regulate the amount of water flowing into and out of the overflow drain. In an additional particular embodiment, the flow-control apparatus may be affixed to the overflow drain and feature adjustable louvers to open and close the access to the overflow drain. Also in particular embodiments, the adjustable louvers on the flow-control apparatus may be operated remotely via communication between a signal transmitter and signal receiver. If desired, the flow-control apparatus may also feature a sensor to automatically detect when to open and close the access to the overflow drain.

The flow-control apparatus can be made from any desired material. However, particular embodiments of the invention may advantageously use hard plastic as the primary material in the flow-control apparatus to avoid corrosion from exposure to chemically-treated water.

The flow-control apparatus may be permanently affixed to the overflow drain cover using any desired method, such as screws. Additionally, the flow-control apparatus may be removable by using any desired method which securely affixes the flow-control apparatus to the overflow drain cover, such as clips. If desired, the flow-control apparatus may also feature additional provisions to ensure the maximum watertight seal between the overflow drain and the flow-control apparatus.

### BRIEF DESCRIPTION OF THE DRAWINGS

FIG. 1 is an isometric view of a flow-control apparatus embodying the principles of the present invention;

FIG. 2 is a side view of a flow-control apparatus embodying the principles of the present invention;

FIG. 3 is a side view of a flow-control apparatus embodying the principles of the present invention with an adjustable surface;

FIG. 4 is a top view of a flow-control apparatus embodying the principles of the present invention featuring adjustable louvers; and

FIG. 5 is a top view of a flow-control apparatus embodying the principles of the present invention with means for electronic control and power.

### DETAILED DESCRIPTION OF THE DRAWINGS

As noted above, exorbitant amounts of chemically-treated water are wasted from swimming pools each year due to such chemically-treated water escaping the pool's overflow drain, leading to a chemically-imbalanced pool and additional, unnecessary expenses for the pool owner. The problem of wasted water is compounded in areas of the world experiencing drought or water shortage. Currently, no known methods exist to remedy the undesired amount of chemically-treated water escaping a swimming pool through the pool's overflow drain.

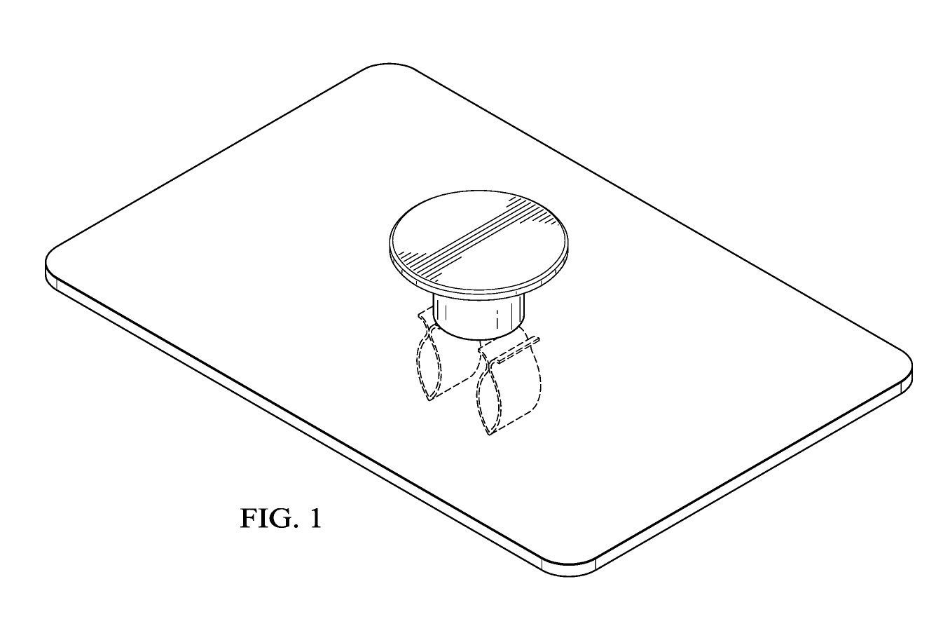

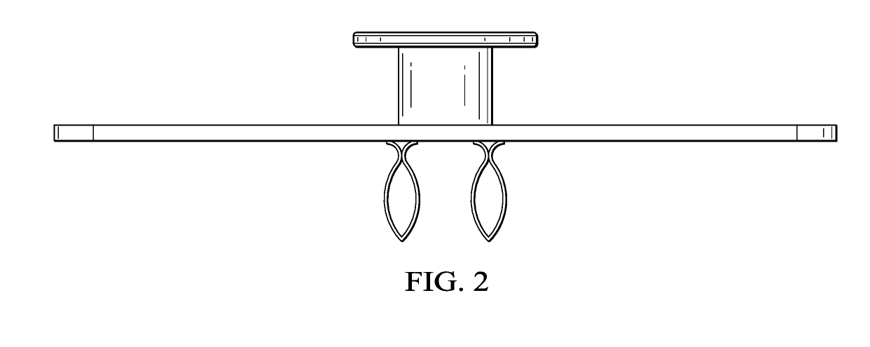

FIGS. 1 and 2 depict a flow-control apparatus embodying the principles of the present invention. Particularly, FIG. 1 depicts an isometric view of a flow-control apparatus embodying the principles of the present invention while FIG. 2 depicts a side view of a flow-control apparatus embodying the principles of the present invention. In a particular embodiment, the flow-control apparatus may be comprised of a planar surface which covers the entirety of the overflow drain cover. In accordance with this particular embodiment, the flow-control apparatus may feature clips affixed to one side of the planar surface of the flow-control apparatus. The clips of the flow-control apparatus may be inserted into the gaps of the overflow drain cover to secure the flow-control apparatus to the overflow drain cover. If desired, grips, such as handles or knobs, may be affixed to the opposite side of the planar surface of the flow-control apparatus to ease manipulation of the flow-control apparatus.

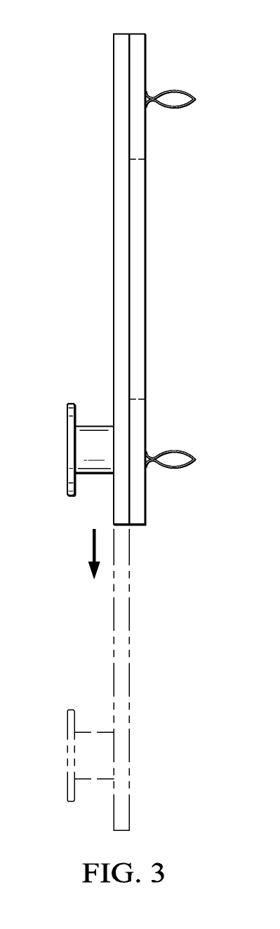

FIG. 3 depicts a flow-control apparatus embodying additional principles of the present invention. Similar to the flow-control apparatus depicted in FIGS. 1 and 2, this embodiment of the flow-control apparatus features a base planar surface with clips which may be used to secure the flow-control apparatus to the overflow drain cover. In accordance with an additional principle of the present invention, the base planar surface may feature an opening in the center with an additional planar surface affixed to the base planar surface. The opening in the center of the base planar surface may act as a fluid outlet to allow access to the overflow drain, whereas the additional planar surface may act as a valve to prevent or allow water to flow into the overflow drain. In such an embodiment, the position of the additional planar surface may be adjusted to cover the opening in the base planar surface and prevent access to the overflow drain when desired; and, conversely, allow access to the overflow drain when desired.

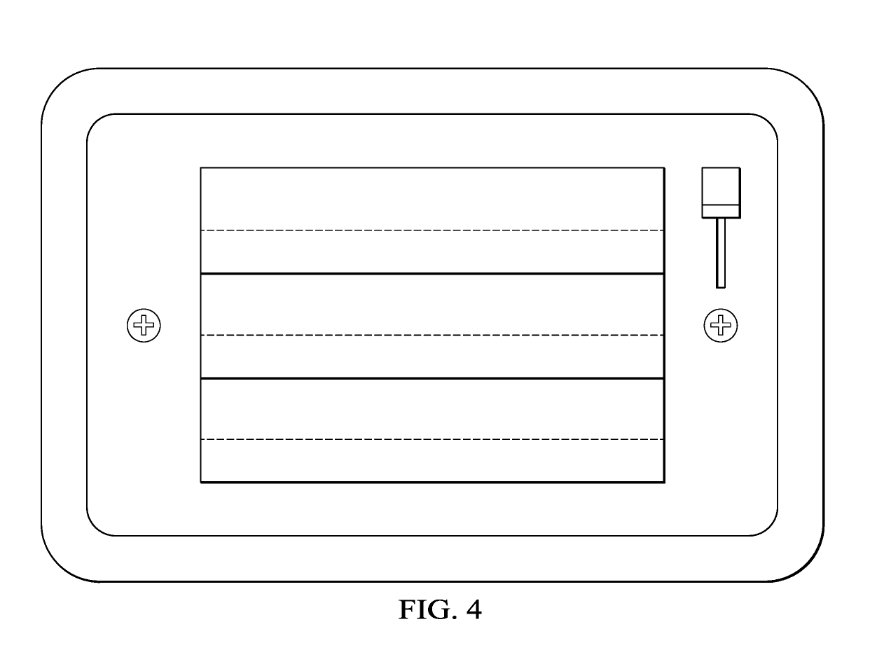

FIG. 4 depicts a flow-control apparatus embodying additional principles of the present invention. In a particular embodiment, the flow-control apparatus may be comprised of a system of adjustable louvers surrounded by a frame to affix the flow-control apparatus to the overflow drain. In this particular embodiment, an adjustment mechanism, such as a switch or knob, may be utilized to change the position of the adjustable louvers. In accordance with an advantageous feature of the invention, such a flow-control apparatus featuring an adjustable louver system allows a user to quickly and easily allow or prevent access to the overflow drain, thereby preventing the undesired escape of chemically-treated water through the overflow drain and allowing proper drainage of any excess water in the swimming pool.

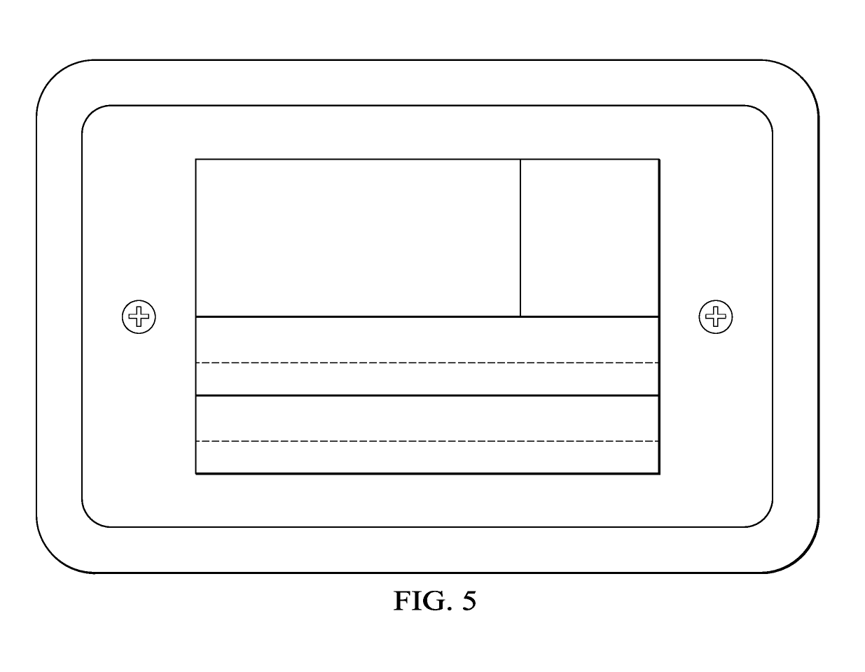

If desired, the flow-control apparatus may also feature electronic means for adjusting the louver position, as depicted in FIG. 5. In such an embodiment, the flow-control apparatus may provide waterproof housing for electronic power means, such as a battery and motor. Additionally, if desired, the flow-control apparatus may feature sensors wherein the louvers may be automatically adjusted when needed to allow or prevent access to the overflow drain.

The foregoing merely illustrates the principles of the invention. Therefore, it will be appreciated that those skilled in the art will be able to devise numerous alternative arrangements that, while not shown or described herein, embody the principles of the invention and thus are within the spirit and scope of the invention.

What is claimed:

1. A flow-control apparatus configured to control the flow of water into and out of an overflow drain on a pool, comprising:
at least one elongated surface;
at least one securing mechanism configured to affix said flow-control apparatus to a drain; and,
at least one hand grip.

2. The flow-control apparatus of claim 1, wherein said hand grip is selected from the group consisting of handle, knob, sunken grip, and hole.

3. The flow-control apparatus of claim 2, wherein said securing mechanism is selected from the group consisting of clips, locks, latches, screws, bolts, and clamps.

4. The flow-control apparatus of claim 3, wherein a first elongated surface includes a hole in the surface and a second elongated surface covers said hole in said first elongated surface.

5. The flow-control apparatus of claim 4, wherein said second elongated surface is positioned on a track integral to said flow-control apparatus and may be temporarily moved to uncover the hole in said first elongated surface.

6. The flow-control apparatus of claim 1, wherein said elongated surface is further comprised of one or more adjustable louvers.

7. The flow-control apparatus of claim 6, wherein the louvers may be adjusted by an adjustment mechanism selected from the group consisting of a switch, knob, dial, motor, and slide bar.
